(19) United States
(12) Patent Application Publication
(10) Pub. No.: US 2013/0136915 A1
(43) Pub. Date: May 30, 2013

(54) DURABLE ENVIRONMENTAL BARRIER COATINGS FOR CERAMIC SUBSTRATES

(71) Applicant: Subhash K. Naik, Carmel, IN (US)

(72) Inventor: Subhash K. Naik, Carmel, IN (US)

(73) Assignee: ROLLS-ROYCE CORPORATION, Indianapolis, IN (US)

(21) Appl. No.: 13/695,193

(22) PCT Filed: Apr. 28, 2011
(86) PCT No.: PCT/US11/34333

§ 371 Date: Feb. 7, 2013

Related U.S. Application Data
(60) Provisional application No. 61/329,758, filed on Apr. 30, 2010.

(51) Int. Cl. C04B 41/89

(52) U.S. Cl. CPC C04B 41/89
USPC 428/312.6; 427/419.7; 427/419.2

(57) ABSTRACT

An article includes a substrate and an environmental barrier coating overlying the substrate. The environmental barrier coating includes a first dense layer, an intermediate layer overlying the first dense layer, and a second dense layer overlying the intermediate layer. The first dense layer includes at least one of a first rare earth silicate or barium strontium aluminosilicate and the second dense layer includes at least one of a second rare earth silicate or barium strontium aluminosilicate. Additionally, the intermediate layer includes at least one of a porous microstructure, a lamellar microstructure, or an absorptive material.

### TECHNICAL FIELD

The disclosure relates to environmental coatings for high temperature mechanical systems.

### BACKGROUND

Components of high-temperature mechanical systems, such as, for example, gas-turbine engines, must operate in severe environments. For example, the high-pressure turbine blades and vanes exposed to hot gases in commercial aeronautical engines typically experience metal surface temperatures of about 1000° C., with short-term peaks as high as 1100° C. Typical components of high-temperature mechanical systems include a Ni or Co-based superalloy substrate. In an attempt to reduce the temperatures experienced by the substrate, the substrate can be coated with a thermal barrier coating (TBC). The thermal barrier coating may include a thermally insulative ceramic topcoat and may be bonded to the substrate by an underlying metallic bond coat. The TBC, usually applied either by air plasma spraying or electron beam physical vapor deposition, is most often a layer of yttria-stabilized zirconia (YSZ) with a thickness of about 100-500 μm. The YSZ TBC also may be made “strain tolerant” and the thermal conductivity further lowered by depositing a structure that contains numerous pores and/or pathways. The properties of an YSZ TBC generally include low thermal conductivity, high oxygen permeability, and a relatively high coefficient of thermal expansion.

Economic and environmental concerns, i.e., the desire for improved efficiency and reduced emissions, continue to drive the development of advanced gas turbine engines with higher inlet temperatures. Some components of high-temperature mechanical systems include a ceramic or ceramic matrix composite (CMC)-based substrate, which may allow an increased operating temperature compared to a component with a superalloy substrate. The ceramic or CMC-based substrate can be coated with an environmental barrier coating (EBC) to reduce exposure of a surface of the substrate to environmental species, such as water vapor or oxygen. The EBC also may provide some thermal insulation to the ceramic CMC-based substrate. The EBC may include a ceramic topcoat, and may be bonded to the substrate by an underlying metallic or ceramic bond coat. As turbine inlet gas temperature continues to increase, there is a demand for a TBC and/or EBC with lower thermal conductivity and higher temperature stability to minimize the increase in, maintain, or even lower the temperatures experienced by the substrate, while providing desired operating lifetimes for the components.

### SUMMARY

In general, the disclosure is directed to a durable coating for a ceramic substrate in a high temperature mechanical system, such as a gas turbine engine. The coating may include a plurality of layers, which may have similar or different compositions. In some embodiments, at least one of the layers includes porous microstructure, a lamellar microstructure, or an absorptive material, while at least one other of the layers includes a dense microstructure. Such a coating may possess improved mechanical or thermal shock resistance compared to a coating that includes only dense material.

When used in high temperature mechanical systems, ceramic substrates may be vulnerable to attack by environmental species, such as water vapor. Water vapor may react with the ceramic substrate and cause recession of the substrate. Such reaction reduces the useful lifetime of a ceramic component in a high temperature mechanical system.

In order to reduce or substantially prevent recession of the ceramic substrate, the substrate may be coated with an environmental barrier coating (EBC). Some EBCs are deposited as substantially nonporous layers which prevent water vapor or other environmental species from contacting and reacting with the ceramic substrate.

Because the EBC may be deposited as a substantially nonporous layer, the EBC may be vulnerable to damage due to mechanical or thermal shock. For example, debris inhaled with intake gases in a gas turbine engine may impact the EBC and damage the EBC due to the force of the impact. This may lead to delamination of a portion of the EBC from the substrate, exposing the substrate to the environmental species against which the EBC was intended to protect. Similarly, sudden changes in temperature may cause thermal stress to the EBC and initiate crack growth in the EBC. Crack growth may eventually lead to failure of a portion of the EBC, again exposing the substrate to the environmental species against which the EBC was intended to protect.

According to some embodiments of this disclosure, damage to an EBC or effects of damage of the EBC on the ceramic substrate may be mitigated by utilizing an EBC including a plurality of layers. In some embodiments, the EBC includes a first dense layer, an intermediate layer, and a second dense layer. In some embodiments, the intermediate layer may impede crack growth within the EBC, may reduce thermal conductivity of the EBC, and/or may break more easily when exposed to a mechanical or thermal shock, which may reduce risk of complete delamination of a portion of the EBC from the substrate. The intermediate layer may include, for example, a porous microstructure, a lamellar microstructure, or an absorptive material.

In one aspect, the disclosure is directed to an article including a substrate and an EBC overlying the substrate. According to this aspect of the disclosure, the EBC includes a first dense layer, an intermediate layer overlying the first dense layer, and a second dense layer overlying the intermediate layer. In some embodiments, the first dense layer includes at least one of a first rare earth silicate or barium strontium aluminosilicate and the second dense layer includes at least one of a second rare earth silicate or barium strontium aluminosilicate. Additionally, the intermediate layer may include at least one of a porous microstructure, a lamellar microstructure, or an absorptive material.

In another aspect, the disclosure is directed to a method that includes depositing a first dense layer over a substrate, depositing an intermediate layer over the first dense layer, and depositing a second dense layer over the intermediate layer. According to this aspect of the invention, the first dense layer may include at least one of a first rare earth silicate or barium strontium aluminosilicate. Additionally, according to this aspect of the invention, the intermediate layer may include at least one of a porous microstructure, a lamellar microstructure, or an absorptive material. Further, the second dense layer may include at least one of a second rare earth silicate or barium strontium aluminosilicate.

### BRIEF DESCRIPTION OF DRAWINGS

FIG. 1 is a cross-sectional diagram illustrating an example of an article including an environmental barrier coating that includes a first dense layer, an intermediate layer, and a second dense layer.

FIG. 2 is a cross-sectional diagram illustrating an example of an article including an environmental barrier coating that includes a first dense layer, a first intermediate layer, a second intermediate layer, and a second dense layer.

FIG. 3 is a cross-sectional diagram illustrating an example of an article including an environmental barrier coating that includes a first dense layer, a first intermediate layer, a second intermediate layer, a second dense layer, a third intermediate layer, and a third dense layer.

FIG. 4 is a flow diagram illustrating an example of a method for forming an article including an environmental barrier coating that includes a first dense layer, an intermediate layer, and a second dense layer.

### DETAILED DESCRIPTION

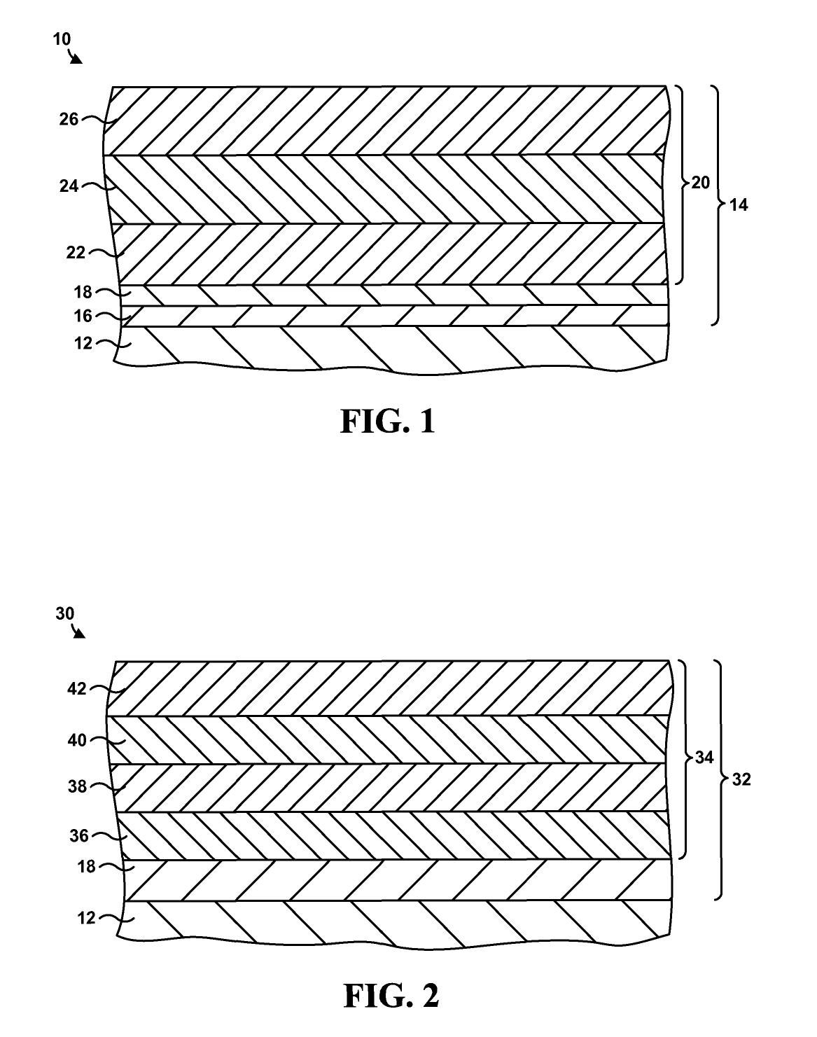

FIG. 1 is a cross-sectional diagram illustrating an example article 10, which may be used in a high temperature mechanical system. Article 10 includes EBC 14 applied to substrate 12. As shown, EBC 14 is a multilayer coating that includes bond layer 16, mullite layer 18, first dense layer 22, intermediate layer 24, and second dense layer 26. In general, EBC 14 may provide environmental protection to allow article 10 to operate in severe environments, e.g., by preventing recession of substrate 12 in a high temperature combustion environment. In some embodiments, EBC 14 also provides thermal insulation to substrate 12, thus lowering temperatures experienced by substrate 12.

Substrate 12 may be a component of a high temperature mechanical system, such as, e.g., a hot section component of a gas turbine engine. Examples of such components may include, but are not limited to, turbine blades, blade tracks, combustion liners, and the like. Substrate 12 may include a ceramic or ceramic matrix composite (CMC). In some embodiments, substrate 12 includes, for example, an oxide-oxide ceramic and/or a silicon-containing ceramic, such as silica (SiO₂), silicon carbide (SiC), silicon nitride (Si₃N₄), or silicon oxynitride. Substrate 12 may additionally or alternatively include an aluminum-containing ceramic, such as, for example, alumina (Al₂O₃), aluminosilicate, or the like. In some embodiments, substrate 12 includes from a metal alloy that includes silicon, such as a molybdenum-silicon alloy (e.g., MoSi₂) or a niobium-silicon alloy (e.g., NbSi₂).

In some embodiments, substrate 12 includes a CMC formed from a matrix material and a reinforcement material. The matrix material may include a ceramic, such as, for example, silicon carbide, silicon nitride, alumina, aluminosilicate, silica, or the like. The CMC may further include any desired reinforcement material, and the reinforcement material may include a continuous reinforcement or a discontinuous reinforcement. For example, the reinforcement material may include chopped or continuous ceramic fibers, whiskers, and/or platelets.

The composition, shape, size, and the like of the reinforcement material may be selected to provide the desired properties to the substrate 12 including the CMC. In some embodiments, the reinforcement material is chosen to increase the toughness of a brittle matrix material. The reinforcement material may additionally or alternatively be chosen to modify a thermal conductivity, electrical conductivity, thermal expansion coefficient, hardness, or the like of a substrate 12 including a CMC.

In some embodiments, the composition of the reinforcement material is the same as the composition of the matrix material. For example, a matrix material comprising silicon carbide may surround a reinforcement material comprising silicon carbide whiskers. In other embodiments, the reinforcement material includes a different composition than the composition of the matrix material, such as aluminosilicate fibers in an alumina matrix, or the like. One composition of a substrate 12 that includes a CMC is a silicon carbide continuous fiber reinforcement material embedded in a silicon carbide matrix material.

Some example CMCs used for substrate 12 include composites of SiC or Si₃N₄ and silicon oxynitride or silicon aluminum oxynitride, and oxide-oxide ceramics, such as a matrix material of alumina or aluminosilicate and a reinforcement material comprising NEXTEL™ Ceramic Oxide Fiber 720 (available from 3M Co., St. Paul, Minn.).

In some embodiments, EBC 14 includes bond layer 16, which in the example of FIG. 1 is applied directly on substrate 12. In other embodiments, EBC 14 may not include bond layer 16, and first dense layer 22 may be deposited directly on mullite layer 18 or substrate 12. In some cases, EBC 14 includes bond layer 16 to promote adherence of mullite layer 18 and/or first dense layer 22 to substrate 12. Bond layer 16 may include silicon, e.g., in the form of high purity, plasma-sprayable grade silicon powder. In other embodiments, bond layer 16 may include another material that is compatible with substrate 12, such as, for example, silica, a silicide, a rare earth silicate, or the like. While EBC 14 is shown with bond layer 16, in some embodiments, EBC 14 may not include bond layer 16. For example, mullite layer 18 may be formed directly on substrate 12 rather than being formed on bond layer 16.

In some embodiments, bond layer 16 may be formed by depositing the appropriate material on substrate 12 via one or more suitable thermal spraying processes, such as, for example, plasma spraying.

Bond layer 16 may formed at any suitable thickness, such as a thickness that allows EBC 14 to provide environmental protection to article 10 as described herein. For example, in one embodiment, bond layer 16 has a thickness between about 0.2 mils and about 5 mils (e.g., measured in a direction substantially normal to a surface of substrate 12 over which bond layer 16 is formed). In some embodiments, bond layer 16 has a thickness between about 0.5 mils and about 5 mils, such as between about 1 mil and about 4 mils or between about 2 mils and about 4 mils.

In some embodiments, EBC 14 also includes mullite layer 18, which may be formed on top of bond layer 16 and/or substrate 12. Whether formed on bond layer 16 or substrate 12, mullite layer 18 overlies substrate 12. In other embodiments, EBC 14 may not include mullite layer 18. Mullite layer 18 may include mullite manufactured by a fused- or sinter-plus-crushed technique. In some embodiments, at least some of the mullite is crystalline mullite. Mullite layer 18 may be formed by depositing mullite powder on substrate 12 or bond layer 16 via one or more suitable thermal spraying processes, including plasma spraying. In some embodiments, mullite layer 18 may include greater than about 50 percent by weight (wt. %) crystalline mullite, such as, e.g., about 60 wt. % crystalline mullite or 80 wt. % crystalline mullite. In some examples, intermediate layer 18 may include about 100 wt. % crystalline mullite.

In some embodiments, mullite layer 18 may further include an amount of barium strontium aluminosilicate (BSAS). For example, in embodiments in which first dense layer 22 includes BSAS, mullite layer 18 may include BSAS. For example, mullite layer 18 may include up to about 80 wt. % BSAS, such as, e.g., about 40 wt. % BSAS or about 20 wt. % BSAS.

In other embodiments, the balance of mullite layer 18 may include an amount of rare earth silicate, e.g., in cases in which first dense layer 22 includes rare earth silicate. For example, mullite layer 18 may include up to about 80 wt. % rare earth silicate, such as, e.g., about 40 wt. % rare earth silicate or about 20 wt. % rare earth silicate.

Mullite layer 18 may be formed at any suitable thickness, such as a thickness that allows EBC 14 to provide environmental protection to article 10 as described herein. For example, in some embodiments, mullite layer 18 has a thickness between about 1 mil and about 7 mils (e.g., measured in a direction substantially normal to a surface of substrate 12 over which mullite layer 18 is formed). In other embodiments, mullite layer 18 has a thickness between about 4 mils and about 6 mils. In some embodiments in which EBC 14 includes bond layer 16 and mullite layer 18, the ratio of layer thickness between bond layer 16 and mullite layer 18 may range between about 0.1 and about 1.5 such as, e.g., between about 0.2 and about 1.0.

EBC 14 also includes a top coating 20, which in the example of FIG. 1 includes first dense layer 22, intermediate layer 24, and second dense layer 26. As will be described below, in some embodiments, top coating 20 includes additional layers. In the example of FIG. 1, top coating 20 has been formed directly on mullite layer 18 such that it is adhered to substrate 12 via mullite layer 18 and bond layer 16. In this way, top coating 20 overlies substrate 12, bond layer 16, and mullite layer 18.

As noted above, in some embodiments, article 10 may not include bond layer 16 and/or mullite layer 18. Thus, in some embodiments, first dense layer 22 is formed on mullite layer 18, in other embodiments, first dense layer 22 may be formed on bond layer 16, and in other embodiments, first dense layer 22 may be formed on substrate 12.

First dense layer 22 may include one or more components selected to provide environmental protection for substrate 12 in combination with other layers in EBC 14 as described herein. In some embodiments, first dense layer 22 may include at least one rare-earth silicate, such as, e.g., a rare earth monosilicate (RE₂SiO₅, where RE is a rare earth element) or a rare earth disilicate (RE₂Si₂O₇, where RE is a rare earth element). The rare earth element may be selected from the group consisting of Lu, Yb, Tm, Er, Ho, Dy, Tb, Gd, Eu, Sm, Pm, Nd, Pr, Ce, La, Y, Sc, or combinations thereof. Additionally or alternatively, first dense layer 22 may include BSAS, e.g., in situations in which the operating temperature of the component is below approximately 2400 degrees Fahrenheit.

In some embodiments, first dense layer 22 may include a rare earth disilicate. In some examples, first dense layer 22 may include a majority (e.g., greater than 50 wt. %) rare earth disilicate. In other cases, first dense layer 22 may consist essentially of a rare earth disilicate. As used herein, “consist essentially of” means that a layer or material includes substantially only the named component, with allowances for minor amounts of impurities, such as impurities present in commercial sources of the named component or impurities formed during the deposition process or during use of the article.

In some embodiments, a rare earth disilicate may have a thermal expansion coefficient which better matches a thermal expansion coefficient of mullite layer 18. Thus, a first dense layer 22 including a rare earth disilicate overlying mullite layer 18 may result in lower stresses at the interface between the layers 18, 22, than when first dense layer 22 includes another material. One rare earth disilicate which first dense layer 22 may include is ytterbium disilicate.

First dense layer 22 may contribute to environmental protection for substrate 12. In some embodiments, first dense layer 22 may be formed to be substantially dense, e.g., may include a relatively low porosity such that substantially no channels or interconnected pores permit environmental species, such as water vapor, to come into contact with substrate 12. For example, first dense layer 22 may include porosity of less than about 12 volume percent (vol. %). In some examples, first dense layer 22 may include porosity of less than about 5 vol. %, or porosity between about 5 vol. % and about 10 vol. %.

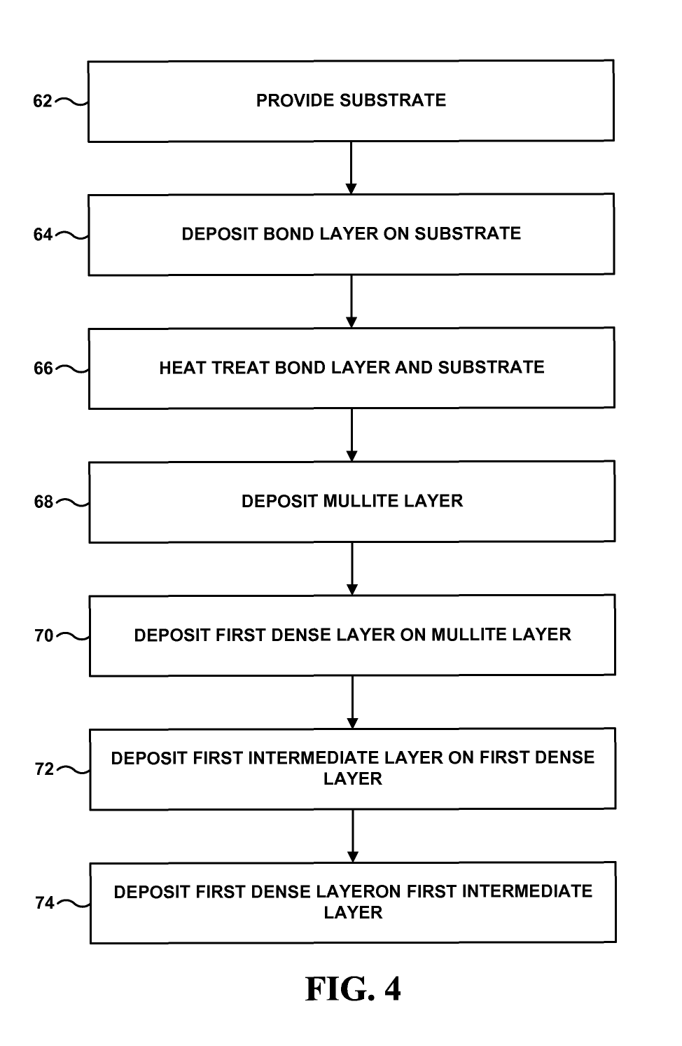

The material selected for first dense layer 22 may be deposited on mullite layer 18 via, for example, a thermal spraying process, physical vapor deposition, chemical vapor deposition, or a slurry process to form first dense layer 22. As will be described in greater detail with respect to FIG. 4, in some embodiments, the material that forms first dense layer 22 may be thermally sprayed on mullite layer 18 to form first dense layer 22 while substrate 12 is maintained at a substantially uniform temperature that is less than 150 degrees Celsius. For example, the material that forms first dense layer 22 may be thermally sprayed on mullite layer 18 to form first dense layer 22 while substrate 12 is maintained at a substantially uniform temperature that is less than 50 degrees Celsius.

In some cases, this may include depositing the material that forms first dense layer 22, e.g., BSAS or one or more rare-earth silicates, via thermal spraying on substrate 12 while the substrate is provided at a temperature that is approximately the same as that of substrate 12 when the mullite material was initially deposited via thermal spraying to form mullite layer 18. Despite the relatively low deposition temperature, it may be possible to form first dense layer 22 including one or more rare earth silicates or BSAS that is adequately bonded to mullite layer 18 while still preventing coating delamination in top coating 20. In this manner, substrate 12 may be coated with mullite layer 18 and first dense layer 22 via thermal spraying without having to provide additional heat to substrate 12 during the application process of EBC 14.

First dense layer 22 may be formed at any suitable thickness, such as a thickness that allows EBC 14 to provide environmental protection and thermal insulation to article 10 as described herein. In some examples, first dense layer 22 may have thickness between about 1 mil and about 4 mils (e.g., measured in a direction substantially normal to a surface of substrate 12 over which first dense layer 22 is formed).

Top coating 20 further includes an intermediate layer 24, which in some embodiments functions as a stress mitigation layer. In some embodiments, intermediate layer 24 is more porous than first dense layer 22. In other embodiments, intermediate layer 24 includes a plurality of lamellae. In other embodiments, intermediate layer 24 includes a material that is able to absorb thermal and/or mechanical stress, such as, for example, boron carbide, mullite, a zirconium silicate, a cermet (a composite of a ceramic material and a metallic material), or a mixed oxide/carbide. A material that is able to absorb thermal and/or mechanical stress is referred to herein as an absorptive material.

In examples in which intermediate layer 24 is more porous than first dense layer 22, intermediate layer 24 may include BSAS and/or a rare earth silicate. In some embodiments, intermediate layer 24 may include one or more similar materials as first dense layer 22. For example, intermediate layer 24 and first dense layer 22 may include a similar rare earth silicate, or intermediate layer 24 and first dense layer 22 may each include BSAS. In other embodiments, first dense layer 22 and intermediate layer 24 may include different materials. For example, first dense layer 22 may include a first rare earth silicate and intermediate layer 24 may include a second, different rare earth silicate.

In examples in which intermediate layer 24 is more porous than first dense layer 22, intermediate layer 24 may include a porosity of greater than about 12 vol. %. In some examples, intermediate layer 24 includes porosity between about 12 vol. % and about 45 vol. %. In other examples, intermediate layer 24 includes porosity between about 12 vol. % and about 35 vol. %.

When intermediate layer 24 includes a porous microstructure, intermediate layer 24 may be deposited by a thermal spraying process, such as, for example, plasma spraying. In some embodiments, the porosity of intermediate layer 24 may be created by depositing an additive along with BSAS or a rare earth silicate, and then removing the additive after deposition of the layer 24. For example, a polyester may be added to the material (e.g., BSAS or rare earth silicate) applied by plasma spraying, and the polyester may be removed by a high-temperature post-deposition heat treatment once intermediate layer 24 has been formed. In other examples, porosity in intermediate layer 24 may be created by properly selecting the power level or gas composition of the plasma spray unit.

In one example, an intermediate layer 24 that includes a porous microstructure is deposited using plasma spraying with argon as the primary gas and hydrogen or helium as the secondary gas. Flow rates of the primary gas range between about 50 standard cubic feet per hour (SCFH) and about 150 SCFH at between about 60 pounds per square inch (psi) and about 120 psi. Flow rates of the secondary gas range between about 10 SCFH and about 60 SCFH at between about 40 psi and about 120 psi. A power level of the plasma torch may be between about 15 kilowatt (kW) and about 50 kW. The powder flow rate of the material for intermediate layer 24 may be between about 1 pound per hour (lb/hr) and about 6 lb/hr. The polyester may be co-sprayed using a second material feeder using an argon carrier gas which is angled so that the polyester rides with the plasma spray flume. Depending on the desired porosity of intermediate layer 24, the flow rate of polyester may be between about 0.02 lb/hr and about 1.0 lb/hr. Once the polyester and the material forming intermediate layer 24 have been deposited on first dense layer 22, the article including intermediate layer 24 may be exposed to a heat treatment above about 600° F. for about 1 hour to about 4 hours to burn off the polyester and form pores in intermediate layer 24.

In another example, an intermediate layer 24 that includes a porous microstructure is deposited using plasma spraying with argon as the primary gas and hydrogen or helium as the secondary gas. Flow rates of the primary gas range between about 70 SCFH and about 150 SCFH at between about 90 psi and about 110 psi. Flow rates of the secondary gas range between about 25 SCFH and about 40 SCFH at between about 60 psi and about 110 psi. A power level of the plasma torch may be between about 20 kW and about 40 kW. The powder flow rate of the material for intermediate layer 24 may be between about 1.5 lb/hr and about 5 lb/hr. The polyester may be co-sprayed using a second material feeder using an argon carrier gas which is angled so that the polyester rides with the plasma spray flume. Depending on the desired porosity of intermediate layer 24, the flow rate of polyester may be between about 0.03 lb/hr and about 0.5 lb/hr. Once the polyester and the material forming intermediate layer 24 have been deposited on first dense layer 22, the article including intermediate layer 24 may be exposed to a heat treatment between about 600° F. and about 850° F. for between about 1 hour and about 2 hours to burn off the polyester and form pores in intermediate layer 24.

When intermediate layer 24 includes a porous microstructure, the porous microstructure may contribute to a relatively low thermal conductivity of top coating 20 compared to a coating that does not include a porous layer. While not wishing to be bound by theory, the porous microstructure of intermediate layer 24 may reduce thermal conductivity of top coating 20 because pores in the porous layer serve as scattering sites for thermal energy-carrying phonons. The scattering of phonons reduces transmission of thermal energy through intermediate layer 24, and thus top coating 20, and therefore lowers an effective thermal conductivity of top coating 20. Additionally or alternatively, the interfaces between first dense layer 22 and intermediate layer 24, and between intermediate layer 24 and second dense layer 26 may provide additional scattering sites for thermal energy-carrying phonons.

In some embodiments, an intermediate layer 24 that includes a porous microstructure also may contribute to stress mitigation in top coating 20. For example, cracks initiated in top coating 20 due to thermal or mechanical shock may grow more slowly in an intermediate layer 24 that includes a porous microstructure than in a more dense EBC material. The cracks may be initiated by impact of a foreign object with top coating 20, e.g., debris in the intake gas, or by thermal gradients within top coating 20, e.g., due to rapid temperature changes to which top coating 20 is exposed during operation. While not wishing to be bound by theory, an intermediate layer 24 that includes a porous microstructure may contribute to stress mitigation within top coating 20 because the pores within layer 24 provide interfaces between two dissimilar materials—the material from which intermediate layer 24 is formed and air or other material in the pores—across which cracks must grow in order to propagate further within intermediate layer 24. This may result in reduced crack growth rates within intermediate layer 24, which may improve stress resistance of top coating 20 compared to a top coating 20 which does not include an intermediate layer 24 that includes a porous microstructure.

In other embodiments, intermediate layer 24 may include a lamellar microstructure. The intermediate layer 24 that includes the lamellar microstructure may include, for example, a rare earth monosilicate, a rare earth disilicate, or BSAS. The lamellar microstructure may include a plurality of lamellae, and may be formed using plasma spraying. The plasma spray process may generally include similar primary and secondary gases, material flow rates, and power levels as described above with respect to forming an intermediate layer 24 having a porous microstructure. However, when plasma spraying used to form a lamellar microstructure, polyester may not be co-deposited with the material that forms intermediate layer 24. Additionally, instead of being oriented substantially perpendicular to the surface of first dense layer 22 (as when depositing an intermediate layer 24 with a porous microstructure), the plasma spray unit may be oriented such that the plume is directed to the surface of first dense layer 22 at an angle between about 30 degrees and about 75 degrees.

Similar to an intermediate layer 24 that includes a porous microstructure, an intermediate layer 24 that includes a lamellar microstructure may contribute to stress mitigation in top coating 20. For example, cracks due to thermal or mechanical shock may grow more slowly in an intermediate layer 24 that includes a lamellar microstructure than in an EBC that does not include a layer that has a lamellar microstructure. While not wishing to be bound by theory, an intermediate layer 24 that includes a lamellar microstructure may contribute to stress mitigation within top coating 20 because the interfaces between the individual lamellae within layer 24 provide interfaces across which cracks must grow in order to propagate further within intermediate layer 24. This may result in reduced crack growth rates within intermediate layer 24, which may improve stress resistance of top coating 20 compared to a top coating 20 which does not include an intermediate layer 24 that includes a lamellar microstructure.

Additionally or alternatively, in some embodiments, the interfaces between individual lamellae within layer 24 may reduce an effective thermal conductivity of top coating 20 compared to a coating which does not include an intermediate layer 24 that has a lamellar microstructure. While not wishing to be bound by theory, the lamellar microstructure may reduce thermal conductivity of top coating 20 because the interfaces between the individual lamellae serve as scattering sites for thermal energy-carrying phonons. Additionally, in some embodiments, voids or pores may form between adjacent lamellae, and the pores or voids may also serve a scattering sites for phonons. As described above, the scattering of phonons may lower an effective thermal conductivity of top coating 20. Additionally or alternatively, the interfaces between first dense layer 22 and intermediate layer 24, and between intermediate layer 24 and second dense layer 26 may provide additional scattering sites for thermal energy-carrying phonons.

In other embodiments, intermediate layer 24 may include an absorptive material. The absorptive material may include a material which absorbs a portion of the energy generated by mechanical or thermal shocks, due to, for example, impact of foreign objects with an outer surface of EBC 14, rapid temperature changes within EBC 14, large thermal gradients within EBC 14, or the like. In some embodiments, the absorptive material includes boron carbide, mullite, a zirconium silicate, a cermet (a ceramic-metallic composite), a mixture of at least one oxide and at least one carbide, or the like.

Second dense layer 26 overlies intermediate layer 24 and, in the embodiment illustrated in FIG. 1, is formed on intermediate layer 24. Second dense layer 26 may include a rare earth silicate (e.g., a rare earth monosilicate and/or a rare earth disilicate) and/or BSAS. The rare earth silicate may be a silicate of at least one of Lu, Ub, Tm, Er, Ho, Dy, Tb, Gd, Eu, Sm, Pm, Nd, Pr, Ce, La, Y, or Sc. In some embodiments, second dense layer 26 includes a rare earth monosilicate, which may have a lower thermal conductivity than a rare earth disilicate. In some embodiments, the rare earth silicate includes an ytterbium monosilicate, an ytterbium disilicate, or a combination of an ytterbium monosilicate and an ytterbium disilicate.

In some embodiments, second dense layer 26 includes a component which first dense layer 26 and/or intermediate layer 24 also includes. In other words, in some embodiments, at least two of first dense layer 22, intermediate layer 24, and second dense layer 26 include a similar component. In other embodiments, second dense layer 26 may include a component different from first dense layer 22 and/or intermediate layer 24. For example, first dense layer 22 may include a rare earth disilicate while second dense layer 26 includes a rare earth monosilicate.

Second dense layer 26 may contribute to environmental protection for substrate 12. In some embodiments, second dense layer 26 may be formed to be substantially dense, e.g., second dense layer 26 may include a relatively low porosity such that second dense layer 26 includes substantially no channels or interconnected pores which permit environmental species, such as water vapor, to come into contact with substrate 12. For example, second dense layer 26 may include porosity of less than about 12 vol. %. In other examples, second dense layer 26 may include porosity of less than about 5 vol. %, or between about 5 vol. % and about 10 vol. %. In some embodiments, porosity of second dense layer 26 is substantially similar to porosity of first dense layer 22, while in other embodiments, porosity of second dense layer 26 is different than porosity of first dense layer 22.

The material selected for second dense layer 26 may be deposited on intermediate layer 24 via, for example, a thermal spraying process, physical vapor deposition, chemical vapor deposition, or a slurry process to form second dense layer 26. As will be described in greater detail with respect to FIG. 4, in some embodiments, the material that forms second dense layer 26 may be thermally sprayed on intermediate layer 24 to form second dense layer 26 while substrate 12 is maintained at a substantially uniform temperature that is less than 150 degrees Celsius. For example, the material that forms second dense layer 26 may be thermally sprayed on intermediate layer 24 while substrate 12 is maintained at a substantially uniform temperature that is less than 50 degrees Celsius.

Second dense layer 26 may be formed at any suitable thickness, such as a thickness that allows EBC 14 to provide environmental protection and, optionally, thermal insulation to article 10 as described herein. For example, in some embodiments, second dense layer 26 may have thickness between about 1 mil and about 4 mils (e.g., measured in a direction substantially normal to a surface of substrate 12 over which second dense layer 26 is formed).

In some embodiments, top coating 20 may provide lower thermal conductivity than an EBC including a single layer, or an EBC including multiple substantially dense layers. While not wishing to be bound by theory, interfaces between first dense layer 22 and intermediate layer 24 and between intermediate layer 24 and second dense layer 26 may provide scattering sites for thermal energy carrying phonons, lowering an effective thermal conductivity of coating 20 compared to a single-layer coating. Additionally, in some embodiments, interfaces between lamellae and/or pores in intermediate layer 24 may provide scattering sites for phonons, also lowering an effective thermal conductivity of coating 20 compared to a coating which does not include a porous or lamellar layer.

In some embodiments, top coating 20 may additionally or alternatively provide improved environmental protection compared to a single-layer EBC. For example, first dense layer 22 and second dense layer 26 may function as redundant environmental protection layers. As both first dense layer 22 and second dense layer 26 may be formed as substantially dense layers which reduce or substantially eliminate exposure of substrate 12 to environmental species, if a portion second dense layer 26 is damaged and delaminates from top coating 20, first dense layer 22 may remain attached to substrate 12 and continue to provide environmental protection to substrate 12. In some embodiments, intermediate layer 24 may facilitate the redundant nature of top coating 20 by providing a layer in which crack growth and delamination preferentially occur. In this way, if top coating 20 experiences a thermal or mechanical shock, intermediate layer 24 may be more likely to fracture, potentially resulting in delamination of a portion of intermediate layer 24 and second dense layer 26, but leaving first dense layer 22 attached to substrate 12.

In some embodiments, intermediate layer 24 may serve to absorb thermal or mechanical shocks experienced by top coating 20 and improve durability of top coating 20 compared to a coating which does not include an intermediate layer 24. For example, intermediate layer 24 may dissipate energy due to thermal or mechanical shocks (e.g., large thermal gradients within top coating 20 or an impact event between top coating 20 and a piece of debris). As described above, intermediate layer 24 also may reduce a rate of crack growth in top coating 20. This may reduce a likelihood that second dense layer 26 delaminates when top coating 20 experiences a thermal or mechanical shock.

Although FIG. 1 illustrates a top coating 20 which includes three layers, in other embodiments, a top coating 20 may include more than three layers. For example, top coating 20 may include alternating dense layers and intermediate layers (i.e., dense layer, intermediate layer, dense layer, intermediate layer, etc.; or intermediate layer, dense layer, intermediate layer, dense layer, etc.). Top coating 20 may include any number of such layers. For example, top coating may include a total of five or more alternating layers.

Regardless of the number of layers in top coating 20, the compositions and microstructures of each layer may be selected independently. As an example, a top coating 20 including five layers may include a first dense layer, a first intermediate layer, a second dense layer, a second intermediate layer, and a third dense layer. The composition of each of these layers may be independently selected. In some embodiments, at least two of the first, second and third dense layers may have a substantially similar composition, while in other embodiments, each of the dense layers includes a different composition. Similarly, at least two of the dense layers may include a substantially similar porosity, or each of the dense layers may include a different porosity.

A composition and microstructure of each of the intermediate layers may also be selected independently. In some embodiments, the first intermediate layer and second intermediate layer include the same microstructure, e.g., porous, lamellar, or absorptive, and the same composition, e.g., rare earth silicate, BSAS, or absorptive material. In other embodiments, the first intermediate layer and second intermediate layer may include the same microstructure but include a different composition. In other embodiments, the first intermediate layer and second intermediate layer may include a different microstructure and the same composition. In still other embodiments, the first intermediate layer and second intermediate layer may include a different microstructure and a different composition.

In some embodiments, each of the layers of top coating 20 may include a thickness between about 1 mil and about 4 mil (e.g., measured in a direction substantially normal to a surface of substrate 12 over which the layer is formed). It will be understood, of course, that the thickness of the individual layers may deviate from this range according to design considerations for top coating 20. In some embodiments, the total thickness of top coating 20 is less than about 18 mils (e.g., measured in a direction substantially normal to a surface of substrate 12 over which top coating 20 is formed).

FIG. 1 has illustrated a top coating 20 which includes dense layers alternating with intermediate layers. In other embodiments, a top coating may include two or more intermediate layers between a first dense layer and a second dense layer. One example of an article including such a top coating is illustrated in FIG. 2. As illustrated in FIG. 2, article 30 includes an EBC 32 overlying substrate 12. EBC 32 includes mullite layer 18 and top coating 34. In the embodiment of FIG. 2, top coating 34 includes first dense layer 36, first intermediate layer 38, second intermediate layer 40, and second dense layer 42.

Substrate 12 and mullite layer 18 may be the same as or substantially similar to the corresponding structures described with respect to FIG. 1. While not shown in FIG. 2, EBC 32 may optionally include bond layer 16, as described with respect to FIG. 1. When EBC 32 includes bond layer 16, layer 16 may be the same as or substantially similar to the bond layer 16 described in reference to FIG. 1, and mullite layer 18 may be formed on bond layer 16. Additionally, in some embodiments, EBC 32 may not include a mullite layer 18. In such embodiments, EBC 32 may or may not include a bond layer 16. Accordingly, in various embodiments, top coating 34 may be formed on substrate 12, bond layer 16, or mullite layer 18.

First dense layer 36 may be the same as or substantially similar to first dense layer 22 described with reference to FIG. 1. For example, first dense layer 36 may include BSAS and/or a rare earth monosilicate and/or disilicate. In some embodiments, first dense layer 36 may be substantially dense, e.g., may include a relatively low porosity such that substantially no channels or interconnected pores permit environmental species, such as water vapor, to come into contact with substrate 12. For example, first dense layer 36 may include porosity of less than about 12 vol. %. In some embodiments, first dense layer 36 may have a thickness between about 1 mil and about 4 mils. First dense layer 36 may be deposited by any suitable technique, including, for example, techniques described above with respect to FIG. 1.

First intermediate layer 38 may include a composition and/or microstructure similar to first intermediate layer 24 described with reference to FIG. 1. For example, first intermediate layer 38 may include a porous microstructure, a lamellar microstructure, or an absorptive material. In examples in which first intermediate layer 38 is more porous than first dense layer 36, first intermediate layer 38 may include BSAS and/or a rare earth silicate. In some embodiments, first intermediate layer 38 may include one or more similar materials as first dense layer 36. For example, first intermediate layer 38 and first dense layer 36 may include one or more similar rare earth silicate, or first intermediate layer 38 and first dense layer 36 may each include BSAS. In other embodiments, first dense layer 36 and first intermediate layer 38 may include different materials. For example, first dense layer 36 may include a first rare earth silicate and first intermediate layer 38 may include a second, different rare earth silicate.

In examples in which first intermediate layer 38 is more porous than first dense layer 36, first intermediate layer 38 may include a porosity of greater than about 12 vol. %. In some examples, first intermediate layer 38 includes porosity between about 12 vol. % and about 45 vol. %. In other examples, first intermediate layer 38 includes porosity between about 12 vol. % and about 35 vol. %.

In other embodiments, first intermediate layer 38 includes a lamellar microstructure. The first intermediate layer 38 that includes the lamellar microstructure may include, for example, at least one of a rare earth monosilicate, a rare earth disilicate, or BSAS. The first intermediate layer 38 that includes the lamellar microstructure may include a plurality of lamellae, and may be formed using plasma spraying. For example, the plasma spray unit may be oriented such that the plume is oriented at an angle to the surface of first dense layer 36 between about 30 degrees and about 75 degrees.

In other embodiments, first intermediate layer 38 may include an absorptive material. The absorptive material may include a material which absorbs mechanical or thermal shocks, due to, for example, impact of foreign objects with an outer surface of EBC 32, rapid temperature changes within EBC 32, large thermal gradients within EBC 32, or the like. In some embodiments, the absorptive material includes at least one of boron carbide, mullite, a zirconium silicate, a cermet (a ceramic-metallic composite), a mixture of at least one oxide and at least one carbide, or the like. First intermediate layer 38 may be deposited by a thermal spraying process, such as, for example, plasma spraying. Examples of some suitable plasma spraying parameters are described above with respect to FIG. 1.

Top coating 34 further includes second intermediate layer 40, which is formed on and overlies first intermediate layer 38. Similar to first intermediate layer 38, second intermediate layer 40 may include a composition and/or microstructure similar to first intermediate layer 24 described with reference to FIG. 1. For example, second intermediate layer 40 may include a porous microstructure, a lamellar microstructure, or an absorptive material. In examples in which second intermediate layer 40 includes a porous microstructure, i.e., is more porous than first dense layer 36, second intermediate layer 40 may include BSAS and/or a rare earth silicate. Second intermediate layer 40 may be deposited by a thermal spraying process, such as, for example, plasma spraying. Examples of some suitable plasma spraying parameters are described above with respect to FIG. 1.

In some embodiments, first intermediate layer 38 and second intermediate layer 40 may include similar compositions. For example, first intermediate layer 38 and second intermediate layer 40 may include a similar rare earth silicate, or first intermediate layer 38 and second intermediate layer 40. In such embodiments, first intermediate layer 38 and second intermediate layer 40 may include different microstructures. For example, first intermediate layer 38 may include a porous microstructure and second intermediate layer 40 may include a lamellar microstructure. Alternatively, first intermediate layer 38 may include a lamellar microstructure and second intermediate layer 40 may include a porous microstructure.

In other embodiments, first intermediate layer 38 and second intermediate layer 40 may include different compositions. For example, first dense layer 36 may include a first rare earth silicate and first intermediate layer 38 may include a second, different rare earth silicate. In examples in which first intermediate layer 38 and second intermediate layer 40 include different compositions, first and second intermediate layers 38 and 40 may include a similar microstructure or different microstructures. In other words, the compositions and microstructures of first intermediate layer 38 and second intermediate layer 40 may be independently selected and may be the same or different.

In examples in which second intermediate layer 40 is more porous than first dense layer 36, second intermediate layer 40 may include a porosity of greater than about 12 vol. %. In some examples, second intermediate layer 40 includes porosity between about 12 vol. % and about 45 vol. %. In other examples, second intermediate layer 40 includes porosity between about 12 vol. % and about 35 vol. %.

In embodiments in which second intermediate layer 40 and first intermediate layer 38 each include a porous layer, the porosity of first intermediate layer 38 and second intermediate layer 40 may be substantially similar or may be different. For example, second intermediate layer 40 may be more porous than first intermediate layer 38, may be less porous than first intermediate layer 38, or may have approximately the same porosity as first intermediate layer 38.

In other embodiments, second intermediate layer 40 includes a lamellar microstructure. The second intermediate layer 40 that includes a lamellar microstructure may include, for example, at least one of a rare earth monosilicate, a rare earth disilicate, or BSAS. The lamellar microstructure may include a plurality of lamellae, and may be formed using plasma spraying. For example, the plasma spray unit may be oriented such that the plume is oriented at an angle to the surface of first intermediate layer 38 between about 30 degrees and about 75 degrees.

In other embodiments, second intermediate layer 40 may include an absorptive material. The absorptive material may include a material which absorbs mechanical or thermal shocks, due to, for example, impact of foreign objects with an outer surface of EBC 32, rapid temperature changes within EBC 32, large thermal gradients within EBC 32, or the like. In some embodiments, the absorptive material includes at least one of boron carbide, mullite, a zirconium silicate, a cermet (a ceramic-metallic composite), a mixture of at least one oxide and at least one carbide, or the like.

In some embodiments, first intermediate layer 38 and second intermediate layer 40 may include similar compositions. For example, first intermediate layer 38 and second intermediate layer 40 may include a similar rare earth silicate, or first intermediate layer 38 and second intermediate layer 40. In such embodiments, first intermediate layer 38 and second intermediate layer 40 may include different microstructures. For example, first intermediate layer 38 may include a porous microstructure and second intermediate layer 40 may include a lamellar microstructure. Alternatively, first intermediate layer 38 may include a lamellar microstructure and second intermediate layer 40 may include a porous microstructure.

In other embodiments, first intermediate layer 38 and second intermediate layer 40 may include different compositions. For example, first dense layer 36 may include a first rare earth silicate and first intermediate layer 38 may include a second, different rare earth silicate. In examples in which first intermediate layer 38 and second intermediate layer 40 include different compositions, first and second intermediate layers 38 and 40 may include similar microstructures or different microstructures. For example first intermediate layer 38 may be porous, lamellar, or absorptive, and second intermediate layer 40 may include a different microstructure selected from porous, lamellar, or absorptive. Alternatively, first intermediate layer 38 may be porous, lamellar, or absorptive, and second intermediate layer 40 may include a similar microstructure. By selecting respective microstructures and compositions for first intermediate layer 38 and second intermediate layer 40, top coating 34 may include desired combinations of thermal and/or mechanical properties, such as low thermal conductivity, shock resilience, chemical and/or mechanical compatibility between adjacent layers, or the like.

For example, first intermediate layer 38 may include a porous structure comprising a rare earth silicate to provide relatively low thermal conductivity while second intermediate layer 40 may include an absorptive material to absorb a portion of energy generated by a mechanical or thermal shock. Other combinations of layer compositions and microstructures are envisioned and are within the scope of this disclosure.

Additionally, top coating 34 includes second dense layer 42. Second dense layer 42 may be the same as or substantially similar to second dense layer 26 described with reference to FIG. 1. For example, second dense layer 42 may include BSAS and/or a rare earth monosilicate and/or disilicate. In some embodiments, second dense layer 42 may be substantially dense, e.g., may include a relatively low porosity such that substantially no channels or interconnected pores permit environmental species, such as water vapor, to come into contact with substrate 12. For example, second dense layer 42 may include porosity of less than about 12 vol. %. In some embodiments, second dense layer 42 may have a thickness between about 1 mil and about 4 mils. In some embodiments, second dense layer 42 includes a similar composition, porosity and/or thickness as first dense layer 36. In other embodiments, at least one of a composition, porosity or thickness of second dense layer 42 is different than that of first dense layer 36.

Second dense layer 42 may be deposited by any suitable technique, including, for example, techniques described above with respect to FIG. 1.

In some embodiments, at least two of first dense layer 36, first intermediate layer 38, second intermediate layer 40, and second dense layer 42 include a similar composition, such as, for example, a rare earth silicate or BSAS. In other examples, at least one of first dense layer 36, first intermediate layer 38, second intermediate layer 40, and second dense layer 42 includes a different composition than another one of first dense layer 36, first intermediate layer 38, second intermediate layer 40, and second dense layer 42. In some examples, each of first dense layer 36, first intermediate layer 38, second intermediate layer 40, and second dense layer 42 includes a different composition.

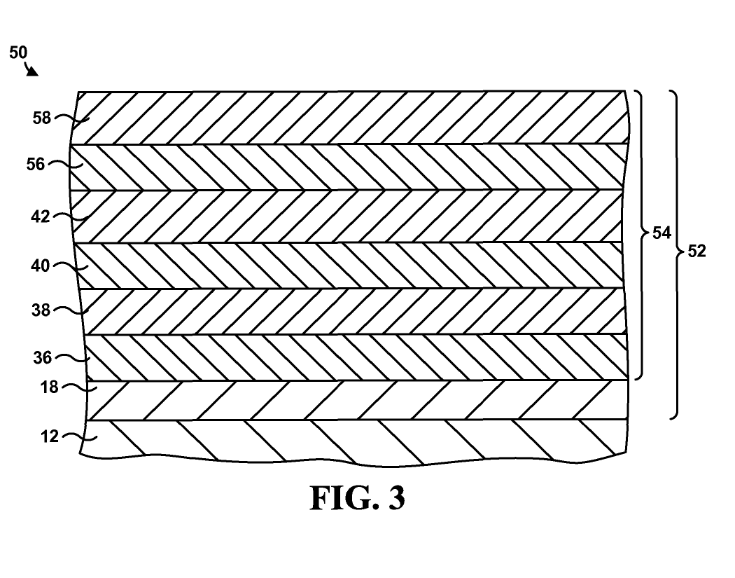

Although FIG. 2 illustrates a top coating 34 including four layers, in other embodiments, top coating 34 may include additional layers. For example, as illustrated in FIG. 3, an article 50 may include an EBC 52 overlying a substrate 12. EBC 52 includes mullite layer 18 and a top coating 54. In the embodiment illustrated in FIG. 3, top coating 54 includes first dense layer 36, first intermediate layer 38, second intermediate layer 40, second dense layer 42, third intermediate layer 56, and third dense layer 58.

Substrate 12 and mullite layer 18 may be the same as or substantially similar to the corresponding structures described with respect to FIG. 1. While not shown in FIG. 3, EBC 52 may optionally include bond layer 16, as described with respect to FIG. 1. When EBC 52 includes bond layer 16, layer 16 may be the same as or substantially similar to the bond layer 16 described in reference to FIG. 1, and mullite layer 18 may be formed on bond layer 16.

First dense layer 36, first intermediate layer 38, second intermediate layer 40, and second dense layer 42 correspond to the layers described above with respect to FIG. 2. As described above, each of first dense layer 36, first intermediate layer 38, second intermediate layer 40, and second dense layer 42 may include an independently selected composition which may be similar to a composition of at least one of the other layers 36, 38, 40, 42 or may be different than a composition of each of the other layers 36, 38, 40, 42. Similarly, first intermediate layer 38 and second intermediate layer 40 may include independently selected microstructures, selected from porous, lamellar, and absorptive material, as described above. In any case, the respective compositions and microstructures of each of first dense layer 36, first intermediate layer 38, second intermediate layer 40, and second dense layer 42 may include any of the compositions and microstructures described herein.

Top coating 54 further includes third intermediate layer 56. Third intermediate layer 56 may include any of the compositions and/or microstructures described with reference to first intermediate layer 24 of FIG. 1 and first intermediate layer 38 and second intermediate layer 38 of FIGS. 2 and 3. For example, third intermediate layer 56 may include a porous microstructure, a lamellar microstructure, or an absorptive material. In examples in which third intermediate layer 56 includes a porous microstructure or a lamellar microstructure, third intermediate layer 56 may include BSAS and/or a rare earth silicate. In some embodiments, third intermediate layer 56 may include one or more similar materials as at least one of first dense layer 36, first intermediate layer 38, second intermediate layer 40, second dense layer 42, or third dense layer 58. In other embodiments, each of the layers 36, 38, 40, 42, 56, 58 may include a different composition. In other words, the composition of each of first dense layer 36, first intermediate layer 38, second intermediate layer 40, second dense layer 42, third intermediate layer 56 and third dense layer 58 is independently selected and may be similar to or different than a composition of each of the other layers 36, 38, 40, 42, 56, 58.

In examples in which third intermediate layer 56 includes a porous microstructure, third intermediate layer 56 may include a porosity of greater than about 12 vol. %. In some examples, third intermediate layer 56 includes porosity between about 12 vol. % and about 45 vol. %. In other examples, third intermediate layer 56 includes porosity between about 12 vol. % and about 35 vol. %.

In other embodiments, third intermediate layer 56 includes a lamellar microstructure. The third intermediate layer 56 that includes the lamellar microstructure may include, for example, at least one of a rare earth monosilicate, a rare earth disilicate, or BSAS. The lamellar microstructure may include a plurality of lamellae, and may be formed using plasma spraying. For example, the plasma spray unit may be oriented such that the plume is oriented at an angle to the surface of second dense layer 42 between about 30 degrees and about 75 degrees.

In other embodiments, third intermediate layer 56 may include an absorptive material. The absorptive material may include a material which absorbs mechanical or thermal shocks, due to, for example, impact of foreign objects with an outer surface of EBC 52, rapid temperature changes within EBC 52, large thermal gradients within EBC 52, or the like. In some embodiments, the absorptive material includes at least one of boron carbide, mullite, a zirconium silicate, a cermet (a ceramic-metallic composite), a mixture of at least one oxide and at least one carbide, or the like.

Third dense layer 58 may be the same as or substantially similar to first dense layer 22 or second dense layer 26 described with reference to FIG. 1, or first dense layer 36 and/or second dense layer 42 described with reference to FIG. 2. For example, third dense layer 58 may include BSAS and/or a rare earth monosilicate and/or disilicate. In some embodiments, third dense layer 58 may be substantially dense, e.g., may include a relatively low porosity such that substantially no channels or interconnected pores permit environmental species, such as water vapor, to come into contact with substrate 12. For example, third dense layer 58 may include porosity of less than about 12 vol. %. In some embodiments, third dense layer 58 may have a thickness between about 1 mil and about 4 mils. In some embodiments, third dense layer 58 includes a similar composition, porosity and/or thickness as first dense layer 36 and/or second dense layer 42. In other embodiments, at least one of a composition, porosity or thickness of third dense layer 58 is different than that of first dense layer 36 and/or second dense layer 42.

Third dense layer 58 may be deposited by any suitable technique, including, for example, techniques described above with respect to FIG. 1.

Other layer configurations are also possible. In fact, any combination of dense layers and intermediate layers is contemplated and within the scope of this disclosure. For example, an EBC may include a top coating with layer order of a first dense layer overlying a substrate, a first intermediate layer overlying the first dense layer, a second dense layer overlying the first intermediate layer, a second intermediate layer overlying the second dense layer, a third intermediate layer overlying the second intermediate layer, and a third dense layer overlying the third intermediate layer. The composition of each of the layers may be independently selected from among the compositions described herein. Similarly, the microstructure of each of the layers may be independently selected from among the microstructures described herein.

FIG. 4 is a flow diagram of an example of a technique for forming an EBC as disclosed herein. For clarity, the technique illustrated in FIG. 4 will be described with reference to article 10 of FIG. 1. However, it will be understood that the technique of FIG. 4 may be utilized to form an article with other coating structures, e.g., with EBCs having other layer configurations. Additionally, other techniques may be utilized to form the article 10 of FIG. 1 and the other articles described in this disclosure.

As indicated in FIG. 4, an uncoated substrate 12 first may be provided at a temperature of less than approximately 50 degrees Celsius (62). In some cases, substrate 12 may undergo one or more preparation steps prior to the being coated with one or more of the layers described herein. For example, substrate 12 may be grit blasted with a suitable material, e.g., aluminum oxide and the like, to prepare the surface of substrate 12 for coating.

In any case, in some embodiments, appropriate silicon material may be deposited of substrate 12 at via any suitable process, including thermal spraying, to form bond layer 16 (64). In some embodiments, the deposition of the silicon material may begin when substrate 12 is at a temperature of less than 50 degrees Celsius. As described above with respect to FIG. 1, in some embodiments article 10 may not include a bond layer 16; accordingly, in some embodiments, the technique illustrated in FIG. 4 may not include the step of depositing silicon on substrate 12 to form bond layer 16 (64). As described above, in some embodiments, bond layer 16 may be deposited to a thickness of between about 0.2 mils and about 5 mils.

Optionally, in some embodiments in which bond layer 16 is deposited on substrate 12, substrate 12 and bond layer 16 may undergo diffusion heat treatment (66). Such a heat treatment may include exposing substrate 12 and bond layer 16 to a relatively high heat environment, e.g., within a furnace, for a relatively short amount of time. In some embodiments, the heat treatment step (66) may include placing substrate 12 and bond layer 16 in an environment at a temperature between about 800° C. and about 1250° C. for an amount of time between about 0.2 hours and about 4 hours. For example, in some embodiments, the heat treatment step (66) may include placing substrate 12 and bond layer 16 in an environment at a temperature between about 1100° C. and about 1225° C. for an amount of time between about 0.5 hours and about 2 hours.

In some embodiments, the inclusion of the diffusion heat treatment step (66) may serve to increase the adhesion of EBC 14 to substrate 12 (in particular, bond layer 16 and substrate 12), especially in cases in which the coefficient of thermal expansion of the layers of EBC 14 are not the substantially the same. In some embodiments, substrate 12 and bond layer 16 may undergo diffusion heat treatment as described above when the coefficients of thermal expansion of layers 16, 18, 20 differ by more than 5 percent, such as, e.g., more than 10 percent, to increase the adhesion of EBC 14 to substrate 12, even when intermediate layer 18 and top coating 20 are formed by deposition of the respective materials via thermal spraying without maintaining substrate 12 at an elevated temperature, e.g., at a temperature greater than 50 degrees Celsius.

After bond layer 16 has optionally been formed on substrate 12, mullite powder that has been manufactured via a fused plus crushed and/or sinter plush crush process may be deposited on bond layer 16 via thermal spraying to form mullite layer 18 (68). Notably, the deposition of the mullite powder on substrate 12 may begin even when substrate 12 is at a substantially uniform temperature of less than 50 degrees Celsius.

After mullite layer 18 has been formed on substrate 12, the material that forms first dense layer 22, e.g., at least one rare earth silicate or BSAS, may be deposited on mullite layer 18 via thermal spraying to form first dense layer 22 (70). Such a deposition process may also begin even when the substrate is at temperature of less than 50 degrees Celsius. In some embodiments, first dense layer 22 may be deposited in a manner which results in low porosity in first dense layer 22. For example, porosity of first dense layer 22 may be less than about 12 vol. %. In some examples, first dense layer 22 may be deposited in a manner which results in porosity of less than about 5 vol. %, or in a manner which results in porosity of between about 5 vol. % and about 10 vol. %.

Plasma spraying is one technique which may be utilized to form first dense layer 22 with a porosity of less than about 12 vol. %. In one embodiment, a plasma spraying technique may utilize argon as the primary gas and hydrogen or helium as the secondary gas Flow rates of the primary gas may range between about 50 SCFH and about 150 SCFH at between about 60 psi and about 120 psi. Flow rates of the secondary gas may range between about 10 SCFH and about 60 SCFH at between about 40 psi and about 120 psi. A power level of the plasma torch may be between about 15 kW and about 50 kW. The powder flow rate of the material for first dense layer 22 may be between about 1 lb/hr and about 6 lb/hr. In some embodiments when low porosity is desired, the material for forming first dense layer 22 may be deposited alone, without polyester.

First intermediate layer 24 then is deposited on first dense layer 22 (72). As described above, first intermediate layer 24 may include a porous microstructure, a lamellar microstructure, or an absorptive material. In some embodiments, such a deposition process may also begin even when substrate 12 is at temperature of less than 50 degrees Celsius.

In examples in which intermediate layer 24 includes a porous microstructure, intermediate layer 24 may include BSAS and/or a rare earth silicate. In some examples, an intermediate layer 24 that includes a porous mictrostructure may be deposited using a thermal spraying process, such as plasma spraying. In examples in which intermediate layer 24 includes a porous microstructure, intermediate layer 24 may include a porosity of greater than about 12 vol. %. In some examples, intermediate layer 24 includes porosity between about 12 vol. % and about 45 vol. %. In other examples, intermediate layer 24 includes porosity between about 12 vol. % and about 35 vol. %.

In some embodiments, the porosity of intermediate layer 24 may be created by depositing an additive along with BSAS or a rare earth silicate, and then removing the additive after deposition of the layer 24. For example, a polyester may be added to the material (e.g., BSAS or rare earth silicate) applied by plasma spraying, and the polyester may be removed by a high-temperature post-deposition heat treatment once intermediate layer 24 has been formed. In other examples, porosity in intermediate layer 24 may be created by properly selecting the power level or gas composition of the plasma spray unit.

In one example, intermediate layer 24 is deposited on first dense layer 22 (72) using plasma spraying with argon as the primary gas and hydrogen or helium as the secondary gas. Flow rates of the primary gas may range between about 50 SCFH and about 150 SCFH at between about 60 psi and about 120 psi. Flow rates of the secondary gas may range between about 10 SCFH and about 60 SCFH at between about 40 psi and about 120 psi. A power level of the plasma torch may be between about 15 kW and about 50 kW. The powder flow rate of the material for intermediate layer 24 may be between about 1 lb/hr and about 6 lb/hr. The polyester may be co-sprayed using a second material feeder using an argon carrier gas which is angled so that the polyester rides with the plasma spray flume. Depending on the desired porosity of intermediate layer 24, the flow rate of polyester may be between about 0.02 lb/hr and about 1.0 lb/hr. Once the polyester and the material forming intermediate layer 24 have been deposited on first dense layer 22, the article including the intermediate layer 24 may be exposed to a heat treatment above about 600° F. for about 1 hour to about 4 hours to burn off the polyester and form pores in intermediate layer 24.

In another example, intermediate layer 24 is deposited on first dense layer 22 (72) using plasma spraying with argon as the primary gas and hydrogen or helium as the secondary gas. Flow rates of the primary gas may range between about 70 SCFH and about 150 SCFH at between about 90 psi and about 110 psi. Flow rates of the secondary gas may range between about 25 SCFH and about 40 SCFH at between about 60 psi and about 110 psi. A power level of the plasma torch may be between about 20 kW and about 40 kW. The powder flow rate of the material for intermediate layer 24 may be between about 1.5 lb/hr and about 5 lb/hr. The polyester may be co-sprayed using a second material feeder using an argon carrier gas which is angled so that the polyester rides with the plasma spray flume. Depending on the desired porosity of intermediate layer 24, the flow rate of polyester may be between about 0.03 lb/hr and about 0.5 lb/hr. Once the polyester and the material forming intermediate layer 24 have been deposited on first dense layer 22, the article including the intermediate layer 24 may be exposed to a heat treatment between about 600° F. and about 850° F. for between about 1 hour and about 2 hours to burn off the polyester and form pores in intermediate layer 24.

In other embodiments, intermediate layer 24 may include a lamellar microstructure. The intermediate layer 24 that includes the lamellar microstructure may include, for example, a rare earth monosilicate, a rare earth disilicate, or BSAS. The lamellar microstructure may include a plurality of lamellae, and may be formed using a thermal spraying process, such as plasma spraying. The plasma spray process may generally include similar primary and secondary gases, material flow rates, and power levels as described above with respect to forming an intermediate layer 24 having a porous microstructure. However, when forming a lamellar microstructure, polyester may not be co-deposited with the material forming intermediate layer 24. Additionally, instead of being oriented substantially perpendicular to the surface of first dense layer 22 (as when depositing an intermediate layer 24 with a porous microstructure), the plasma spray unit may be oriented such that the plume is oriented at an angle to the surface of first dense layer 22 between about 30 degrees and about 75 degrees.

After first intermediate layer 24 has been formed on first dense layer 22 (72), the second dense layer material, e.g., at least one rare earth silicate or BSAS, may be deposited on first intermediate layer 24 via thermal spraying to form second dense layer 26 (74). In some embodiments, such a deposition process may also begin even when the substrate is at temperature of less than 50 degrees Celsius. In some embodiments, second dense layer 26 may be deposited in a manner which results in low porosity in second dense layer 26. For example, porosity of second dense layer 26 may be less than about 12 vol. %. In some examples, second dense layer 26 may be deposited in a manner which results in porosity of less than about 5 vol. %, or in a manner which results in porosity of between about 5 vol. % and about 10 vol. %. As described above, porosity of second dense layer 26 may be substantially similar to or different from porosity of first dense layer 22.

In this manner, the respective layers 16, 18, 22, 24, 26 of EBC 14 may be applied to substrate 12 in a relatively low temperature air environment while still forming a suitable coating that provides environmental protection to substrate in a high temperature combustion environment.

Plasma spraying is one technique which may be utilized to form second dense layer 26 with a porosity of less than about 12 vol. %. In one embodiment, a plasma spraying technique may utilize argon as the primary gas and hydrogen or helium as the secondary gas Flow rates of the primary gas may range between about 50 SCFH and about 150 SCFH at between about 60 psi and about 120 psi. Flow rates of the secondary gas may range between about 10 SCFH and about 60 SCFH at between about 40 psi and about 120 psi. A power level of the plasma torch may be between about 15 kW and about 50 kW. The powder flow rate of the material for second dense layer 26 may be between about 1 lb/hr and about 6 lb/hr. In some embodiments when low porosity is desired, the material for forming second dense layer 26 may be deposited alone, without polyester.

As illustrated by the example of FIG. 4, in some embodiments, one or more layers of EBC 14 may be deposited on substrate 12 via thermal spraying even when the temperature of substrate 12 is a relatively low, which may include temperatures realized without purposefully elevating the temperature of the substrate 12 above that generally exhibited under normal conditions. For example, in FIG. 4, at least one of bond layer 16, mullite layer 18, first dense layer 22, first intermediate layer 24, and second dense layer 26 may be formed on substrate 12 via thermal spraying when the substrate 12 is at a substantially uniform temperature of less than approximately 50 degrees Celsius. Such a temperature limit may generally correspond to the maximum temperature that may be naturally exhibited in a space without providing substantial supplemental heat to the space beyond that provided by conventional device or systems that may be used to control the temperature of a room, e.g., from a heating, ventilation and air conditioning (HVAC) system. In particular, the low temperature process may be achieved without requiring substrate 12 to be heated in a furnace or purposefully providing supplemental heat directed to substrate 12 for purposes of heating all or portions of substrate 12 during the deposition process.

Depending in part on the environment that the layer deposition process is undertaken, e.g., the natural temperature of the room at which the deposition process is undertaken, substrate 12 may be at a temperature less than approximately 50 degrees Celsius at the beginning of the deposition of at least one of layers 16, 18, 22, 24, and 26, which includes the beginning of the deposition of the mullite powder on the substrate (68), as previously described. For example, substrate 12 may be at a temperature of less than approximately 40 degrees Celsius at the beginning of the mullite powder deposition, such as, e.g., between approximately 15 degrees Celsius and approximately 35 degrees Celsius. In some embodiments, substrate 12 is not be substantially heated above the temperature of the surrounding space in which the thermal spraying of the layer material is being performed, wherein the ambient temperature of the surrounding space, e.g., the room in which the thermal spraying process is performed, is less than approximately 50 degrees. In some embodiments, the ambient temperature of the surrounding space may be between approximately 10 degrees Celsius and 40 degrees Celsius, such as, e.g., between approximately 15 degrees Celsius and 30 degrees Celsius.

Despite the relatively low temperatures of the substrate during thermal spraying, mullite layer 18 may contain a concentration of stoichiometric and/or homogenous amorphous and crystalline mullite phases such that cracking and/or delamination of mullite layer 18 is reduce or substantially prevented during thermal cycling. In this manner, at least one of layers 16, 18, 22, 24, 26 may be formed via thermal spraying of mullite powder without having to provide additional heat to substrate 12 to a temperature substantially greater than that of the space.

While substrate 12 may be at a temperature of less than 50 degrees Celsius at the beginning of the deposition of the materials of layers 16, 18, 22, 24 and/or 26, it is recognized that the local temperature of certain portions of substrate 12 may be increased above approximately 50 degrees Celsius, including local temperature greater than or equal to that of 50 degrees, at periods throughout the overall deposition time of the respective layer material. For example, during thermal spraying of mullite powder on substrate 12 to form mullite layer 18, the deposition surface of substrate 12 may reach temperatures greater than or equal to 50 degrees Celsius because of elevated temperature of the material being deposited on the surface of substrate 12. However, while the temperature of substrate 12 may increase above the temperature at the beginning of the mullite deposition, it is as a result from the heat provided by the thermal spraying process rather than by a supplemental source, as would be the case in a furnace or even provided additional heat directed to substrate 12. Even with the additional heat from the thermal spraying process, in some embodiments, substrate 12 may be maintained at a temperature of less than 200 degrees Celsius, such as, for example, between approximately 15 degrees Celsius and approximately 200 degrees Celsius or between approximately 20 degrees Celsius and approximately 150 degrees Celsius, throughout the deposition of the mullite material via thermal spraying.

The beginning temperature of substrate 12 relative the deposition of one or more of the layer materials may be achieved via any suitable method. Importantly, substrate 12 may be at a temperature of less than approximately 50 degrees Celsius by simply allowing the temperature of substrate 12 to be substantially equal to that of the room temperature of the surrounding space, assuming that that surrounding space is less than approximately 50 degrees Celsius. This may allow EBC 14, and mullite layer 18, in particular, to be formed on substrate 12 via a thermal spraying process without having to undertake any additional steps to heat substrate 12 during the deposition and/or heat treat substrate 12 after being coated with EBC 14.

Although the foregoing description has been directed to an EBC formed on a ceramic or CMC substrate, the concepts described herein may be extended to a thermal barrier coating (TBC) formed over a superalloy, ceramic, or CMC substrate. In embodiments in which a TBC is formed over a ceramic or CMC substrate, the ceramic or CMC substrate may include any of the materials described herein. In embodiments in which the TBC is formed over a superalloy substrate, the substrate may include an alloy based on Ni, Co, Ni/Fe, or the like. The superalloy substrate may include other additive elements to alter its mechanical properties, such as toughness, hardness, temperature stability, corrosion resistance, oxidation resistance, and the like, as is well known in the art. Any useful superalloy may be utilized in the substrate, including, for example, those available from Martin-Marietta Corp., Bethesda, Md., under the trade designation MAR-M247; those available from Cannon-Muskegon Corp., Muskegon, Mich., under the trade designations CMSX-4 and CMSX-10; and the like.

In some embodiments, the TBC includes a bond layer which overlies the substrate and facilitates adhesion between the overlying TBC layers and the substrate. In examples in which the substrate includes a ceramic or CMC, the bond layer may include any of the materials described herein, such as, for example, silicon, silica, a silicide, a rare earth silicate, or the like. In embodiments in which the substrate includes a superalloy, the bond layer may include an alloy, such as an MCrAlY alloy (where M is Ni, Co, or NiCo), a β-NiAl nickel aluminide alloy (either unmodified or modified by Pt, Cr, Hf, Zr, Y, Si, and combinations thereof), a γ-Ni+γ′-Ni₃Al nickel aluminide alloy (either unmodified or modified by Pt, Cr, Hf, Zr, Y, Si, and combination thereof), or the like.

The composition and resulting phase constitution of the bond layer may be selected based on a number of considerations, including the chemical composition and phase constitution of the substrate and the layer overlying the bond layer. For example, when the substrate includes a superalloy with a γ-Ni+γ′-Ni₃Al phase constitution, the bond layer may include a γ-Ni+γ′-Ni₃Al phase constitution to better match the coefficient of thermal expansion of the superalloy substrate. This may increase the mechanical stability (adhesion) of the bond layer to the substrate.

The TBC may further include a first dense layer, an intermediate layer, and a second dense layer. In some examples, the first dense layer includes a TBC material, such as, for example, yttria-stabilized zirconia. The TBC material may additionally or alternatively include yttria-stabilized hafnia, zirconia stabilized by at least two rare earth oxides, hafnia stabilized by at least two rare earth oxides, or the like. In some embodiments, the first dense layer includes a porosity of less than about 12 vol. %, as described above. In other embodiments, the first dense layer may include a porosity of greater than about 12 vol. %.

The intermediate layer includes a porous microstructure, a lamellar microstructure, or an absorptive material, as described above with reference to FIGS. 1-4. In addition to or as an alternative to the materials described above, the intermediate layer may include at least one of yttria-stabilized zirconia, yttria-stabilized hafnia, zirconia stabilized with at least two rare earth oxides, or hafnia stabilized with at least two rare earth oxides. The intermediate layer may include any of the microstructures described with respect to FIGS. 1-4, and may be formed by similar methods to those described above.

Similar to the first dense layer, the second dense layer may include a TBC material. In some embodiments, the first dense layer and the second dense layer include a substantially similar composition, while in other embodiments, the first dense layer has a different composition than the second dense layer. Similarly, the first and second dense layers may include a similar porosity or different porosities.

As described above with respect to FIGS. 1-4, in some embodiments, the layered structure may contribute to lower thermal conductivity of the TBC compared to a single layer TBC. Additionally or alternatively, the layered structure of the TBC may improve thermal and/or mechanical shock resistance compared to a TBC which does not include an intermediate layer.

A TBC may include any of the layer combinations described above with respect to FIGS. 1-4. For example, a TBC may include a first dense layer, a first intermediate layer, a second intermediate layer and a second dense layer. As another example, a TBC may include a first dense layer, a first intermediate layer, a second dense layer, a second intermediate layer, and a third dense layer. Other layer combinations are also contemplated, as described with respect to FIGS. 1-4.

1. An article comprising:
a substrate; and
an environmental barrier coating overlying the substrate, wherein the environmental barrier coating comprises:
a first dense layer comprising at least one of a first rare earth silicate or barium strontium aluminosilicate, wherein the first dense layer comprises a porosity of less than about 12 volume percent;
an intermediate layer overlying the first dense layer, wherein the intermediate layer comprises at least one of a porous microstructure comprising a porosity of greater than about 12 volume percent or a lamellar microstructure; and
a second dense layer overlying the intermediate layer, wherein the second dense layer comprises at least one of a second rare earth silicate or barium strontium aluminosilicate, and wherein the second dense layer comprises a porosity of less than about 12 volume percent.

2. The article of claim 1, wherein at least one of the first dense layer or the second dense layer comprises a porosity of less than about 5 volume percent.

3. The article of claim 1, wherein the intermediate layer comprises the porous microstructure, wherein the intermediate layer comprises at least one of a rare earth monosilicate, a rare earth disilicate, or barium strontium aluminosilicate, and wherein the porosity of the intermediate layer is between about 12 volume percent and about 45 volume percent.

4. The article of claim 1, wherein the intermediate layer comprises the lamellar microstructure, and wherein the lamellar microstructure comprises a plurality of lamellae formed from at least one of a rare earth silicate or barium strontium aluminosilicate.

5. The article of claim 7, wherein the second intermediate layer comprises the absorptive material, and wherein the absorptive material comprises at least one of boron carbide, mullite, a zirconium silicate, a cermet, or a mixed oxide/carbide.

6. The article of claim 1, wherein the intermediate layer comprises a first intermediate layer, and wherein the environmental barrier coating further comprises:
a second intermediate layer, wherein the second intermediate layer overlies the second dense layer, and wherein the second intermediate layer comprises at least one of a porous microstructure, a lamellar microstructure or an absorptive material; and
a third dense layer overlying the second intermediate layer, wherein the third dense layer comprises a porosity of less than about 12 volume percent.

7. The article of claim 1, wherein the intermediate layer comprises a first intermediate layer, and wherein the environmental barrier coating further comprises:
a second intermediate layer, wherein the second intermediate layer comprises at least one of a porous microstructure, a lamellar microstructure or an absorptive material, wherein the second intermediate layer overlies the first intermediate layer, and wherein the second dense layer overlies the second intermediate layer.

8. The article of claim 1, wherein the environmental barrier coating further comprises a bond layer overlying the substrate, wherein the bond layer comprises silicon, and wherein the first dense layer overlies the bond layer.

9. The article of claim 8, wherein the environmental barrier coating further comprises a mullite layer overlying the bond layer, wherein the mullite layer comprises at least one of fused-plus-crushed mullite or sintered-plus-crushed mullite, and wherein the first dense layer overlies the mullite layer.

10. A method of forming an environmental barrier coating comprising:
depositing a first dense layer over a substrate, wherein the first dense layer comprises at least one of a first rare earth silicate or barium strontium aluminosilicate, wherein the first dense layer comprises a porosity of less than about 12 volume percent;
depositing an intermediate layer over the first dense layer, wherein the intermediate layer comprise at least one of a porous microstructure comprising a porosity of greater than about 12 volume percent or a lamellar microstructure; and
depositing a second dense layer over the intermediate layer, wherein the second dense layer comprises at least one of a second rare earth silicate or barium strontium aluminosilicate, wherein the second dense layer comprises a porosity of less than about 12 volume percent.

11. The method of claim 10, wherein at least one of the first dense layer or the second dense layer comprises a porosity of less than about 5 volume percent, wherein the intermediate layer comprises the porous microstructure, and wherein the intermediate layer comprises a porosity of between about 12 volume percent and about 45 volume percent.

12. The method of claim 14, wherein the second intermediate layer comprises the absorptive material, and wherein the absorptive material comprises at least one of boron carbide, mullite, a zirconium silicate, a cermet, or a mixed oxide/carbide.

13. The method of claim 10, further comprising:
depositing a bond layer comprising silicon over the substrate; and
depositing a mullite over the bond layer during a first time period via thermal spraying to form a mullite layer, wherein the mullite comprises mullite powder formed via at least one of a fused plus crush or sinter plus crush process, wherein the substrate is at a temperature less than approximately 50° C. at approximately a beginning of the first time period, and wherein depositing the first dense layer over the substrate comprises depositing the first dense layer over the mullite layer.

14. The method of claim 10, wherein depositing the intermediate layer over the first dense layer comprises depositing a first intermediate layer over the first dense layer, and wherein the method further comprises:
depositing a second intermediate layer over the first intermediate layer, wherein the second intermediate layer comprises at least one of a porous microstructure, a lamellar microstructure, or an absorptive material, and wherein the second dense layer is deposited over the second intermediate layer.

15. The method of claim 10, wherein depositing the intermediate layer over the first dense layer comprises depositing a first intermediate layer over the first dense layer, and wherein the method further comprises:
depositing a second intermediate layer over the second dense layer, wherein the second intermediate layer comprises at least one of a porous microstructure, a lamellar microstructure, or an absorptive material; and
depositing a third dense layer over the second intermediate layer, wherein the third dense layer comprises a porosity of less than about 12 volume percent.

16. The article of claim 1, wherein the first dense layer comprises a rare earth disilicate.

17. An article comprising:
a substrate, wherein the substrate comprises at least one of a ceramic or a ceramic matrix composite; and
an environmental barrier coating overlying the substrate, wherein the environmental barrier coating comprises:
a bond layer overlying the substrate, wherein the bond layer comprises silicon,
a mullite layer overlying the bond layer, wherein the mullite layer comprises at least one of fused-plus-crushed mullite or sintered-plus-crushed mullite,
a first dense layer overlying the mullite layer, wherein the first dense layer consists essentially of a rare earth disilicate, wherein the first dense layer comprises a porosity of less than about 12 volume percent,
an intermediate layer overlying the first dense layer, wherein the intermediate layer comprises at least one of a porous microstructure comprising a porosity of greater than about 12 volume percent, a lamellar microstructure or an absorptive material; and
a second dense layer overlying the intermediate layer, wherein the second dense layer comprises at least one of a second rare earth silicate or barium strontium aluminosilicate, wherein the second dense layer comprises a porosity of less than about 12 volume percent.

18. The article of claim 17, wherein the first dense layer comprises a porosity of less than about 5 volume percent and the second dense layer comprises a porosity of less than about 5 volume percent.

19. The article of claim 17, wherein the intermediate layer comprises the porous microstructure, wherein the intermediate layer comprises at least one of a rare earth monosilicate, a rare earth disilicate, or barium strontium aluminosilicate, and wherein the porosity of the intermediate layer is between about 12 volume percent and about 35 volume percent.

20. The article of claim 17, wherein the intermediate layer comprises the lamellar microstructure, and wherein the lamellar microstructure comprises a plurality of lamellae formed from at least one of a rare earth silicate or barium strontium aluminosilicate.
